(19) United States
(12) Patent Application Publication
(10) Pub. No.: US 2026/0085915 A1
(43) Pub. Date: Mar. 26, 2026

(54) ELECTRONIC SHOOTING TARGET THROWING SYSTEM

(71) Applicant: AOB Products Company, Columbia, MO (US)

(72) Inventors: Kyle Martin, Columbia, MO (US); Mark Schaumburg, Columbia, MO (US); Kolten Kelsey, Columbia, MO (US); Michael Cottrell, Columbia, MO (US); James Tayon, Columbia, MO (US)

(73) Assignee: AOB Products Company, Columbia, MO (US)

(21) Appl. No.: 19/340,419

(22) Filed: Sep. 25, 2025

Related U.S. Application Data
(60) Provisional application No. 63/699,152, filed on Sep. 25, 2024.
(60) Provisional application No. 63/699,435, filed on Sep. 26, 2024.
(60) Provisional application No. 63/706,359, filed on Oct. 11, 2024.

(51) Int. Cl. F41J 9/24; H04W 4/80; H04W 84/18

(52) U.S. Cl. CPC F41J 9/24; H04W 4/80; H04W 84/18

(57) ABSTRACT

An electronic shooting target throwing system includes throwers configured to launch shooting targets into the air. The throwers are communicatively connected to one another to form a mesh network. A first subgroup of one or more of the throwers is located within a communication range of a remote control (RC) and a second subgroup of one or more of the throwers is outside of the communication range. In response to a first thrower of the first subgroup receiving a command message communicated from the RC that identifies at least a second throwers that is in the second subgroup as an intended recipient of the command message, the first thrower is configured to communicate the command message to at least the second thrower, effectively extending the communication range of the RC.

### CROSS-REFERENCE TO RELATED APPLICATIONS

This application relates to and claims priority benefits from U.S. Provisional Patent Application No. 63/699,152, filed Sep. 25, 2024; U.S. Provisional Patent Application No. 63/699,435, filed Sep. 26, 2024; and U.S. Provisional Patent Application No. 63/706,359, filed Oct. 11, 2024, which are all incorporated herein by reference in their entireties.

### FIELD

The present disclosure generally relates to shooting target throwers, such as clay pigeon shooters, trap shooters, and skeet shooters.

### BACKGROUND

Electronic shooting target throwers provide a safe and low effort way to launch shooting targets into the air to practice marksmanship with a moving target. Conventional implementations include a wired switch to activate the thrower.

### SUMMARY

In one aspect, an electronic shooting target throwing system includes a plurality of thrower s each configured to launch shooting targets into the air as projectiles. Each of the throwers includes at least one wireless interface and a thrower controller. The throwers are communicatively connected to one another to form a mesh network. A first subgroup of one or more of the thrower s is located within a communication range of a remote control (RC) and a second subgroup of one or more of the thrower s is outside of the communication range. In response to a first thrower of the first subgroup receiving a command message communicated from the RC that identifies at least a second thrower s that is in the second subgroup as an intended recipient of the command message, the first thrower is configured to communicate the command message to at least the second thrower, effectively extending the communication range of the RC.

In another aspect, an electronic shooting target throwing system includes a remote control (RC). The RC includes a control system and at least a first wireless interface. The RC is configured to generate a command message and wirelessly communicate the command message, via the first wireless interface, to one or more thrower s. Each thrower is configured to launch shooting targets into the air as projectiles. The RC generates the command message to include a command identifier and an operation instruction to launch at least one shooting target. The command identifier uniquely identifies the particular command message communicated by the RC so as to avoid the one or more throwers executing the same command message more than once.

In another aspect, an electronic shooting target throwing system comprises a remote control (RC) including a control system and at least a first wireless interface. The RC is configured to generate a command message and wirelessly communicate the command message, via the first wireless interface, to one or more throwers. Each thrower is configured to launch shooting targets into the air as projectiles. The RC generates the command message to include an operation instruction to launch at least one shooting target. The RC is configured to establish a communication link to at least a first thrower of the one or more throwers. A pairing procedure to establish the communication link involves physical enablement of pairing on the first thrower and multiple linking signals communicated by the RC.

In another aspect, an electronic shooting target throwing system comprises a remote control (RC) including a control system and at least a first wireless interface. The RC is configured to generate a command message and wirelessly communicate the command message, via the first wireless interface, to one or more throwers. Each thrower is configured to launch shooting targets into the air as projectiles. The RC generates the command message to include an operation instruction that instructs a first thrower of the one or more throwers and a second thrower of the one or more throwers to launch a plurality of shooting targets in a designated launch sequence.

Other objects and features of the present disclosure will be in part apparent and in part pointed out herein.

### BRIEF DESCRIPTION OF THE DRAWINGS

FIG. 1 is a schematic diagram of an electronic shooting target throwing system according to an embodiment;

FIG. 2 is a schematic diagram of a control system of the electronic shooting target throwing system according to an embodiment;

FIG. 3 is a schematic diagram of a remote control (RC) of the electronic shooting target throwing system according to an embodiment;

FIG. 4 is a schematic diagram of one thrower of the electronic shooting target throwing system according to an embodiment;

FIG. 5 is a schematic diagram of the electronic shooting target throwing system according to a second embodiment;

FIG. 6 is a schematic diagram of the electronic shooting target throwing system according to a third embodiment;

FIG. 7 is a schematic diagram showing the contents of a command message according to an embodiment;

FIG. 8 illustrates a shooting target thrower launching a shooting target;

FIG. 9 illustrates a first RC ;

FIG. 10 illustrates a second RC ;

FIG. 11 illustrates an RC in communication with a mesh network of connected thrower s;

FIG. 12 shows a first example one-to-many configuration in which a single RC controls multiple thrower s via RF-transmitted command signals;

FIG. 13 shows a second example configuration of the electronic shooting target throwing system; and

FIG. 14 shows a third example configuration of the electronic shooting target throwing system.

Corresponding reference characters indicate corresponding parts throughout the drawings.

### DETAILED DESCRIPTION

The embodiments described herein provide safe and convenient use of wireless communications for controlling target throwers. One or more different types of wireless transmissions may be used to transmit a command message to at least one thrower to control the operation of the thrower(s). The remote control (RC) described herein may use radio frequency (RF) wireless communications and/or Bluetooth communications according to the Bluetooth short-range wireless technology standard. The remote control described herein may use other types of wireless communications (e.g., infrared) without departing from the scope of the present disclosure.

One or more technical effects of the embodiments described herein is enhanced functionality of the target throwers. For example, a user with the remote control is able to control one or more connected target throwers, from a distance, to launch a series of projectiles according to a user-selected throwing pattern. The electronic shooting target throwing system described herein enables the user to, for example, control multiple target throwers to launch a plurality of shooting targets at the same time, in an ordered sequence, in a random sequence, or the like, as selected by the user. Furthermore, the electronic shooting target throwing system may provide a mesh communication network that enables wireless command messages to be communicated a distance that is greater than the direct communication range of the remote control, enabling remote control over target throwers that are out of range of the remote control. The target throwers may function as nodes in the mesh network, enabling intermediary throwers to relay received command messages to intended recipient target throwers. Furthermore, the messages conveyed between the components of the electronic shooting target throwing system have unique identifiers to provide security and reduce the risk of throwers executing the same command twice and/or executing commands sent by non-verified wireless devices.

FIG. 1 is a schematic diagram of an electronic shooting target throwing system 100 according to an embodiment. The electronic shooting target throwing system 100 (broadly, system 100) includes one or more target throwers 102 and a thrower actuator 104 (e.g., a remote control or RC). The remote control 104 is able to wirelessly communicate with the one or more target throwers 102. The RC 104 may be a handheld, mobile electronic transmitter. In an example, the RC 104 may be a mobile computing device, such as a smartphone, tablet computer, wearable computer, or the like. In another example, the RC 104 is an RF transmitter. The RF transmitter may lack the computing hardware and circuitry of a smartphone, tablet computer, and wearable computer. The RC 104 wirelessly communicates with the one or more target throwers 102 via RF, Bluetooth, and/or the like.

The system 100 includes a control system 106 that provides the enhanced operability of the system 100 described herein. The control system 106 performs at least one of the operations described herein to control the launching sequence of the targets. For example, the control system 106 generates command messages that are communicated to the target thrower(s) 102 to control the launching of the shooting targets. The command messages may include information regarding the intended target thrower(s) 102, the timing of target launch, the number of targets to launch, the direction and/or elevation (e.g., launch angle) at which to throw the targets, and/or the like. In the illustrated embodiment, the control system 106 is part of the RC 104. Other configurations can be used without departing from the scope of the present disclosure.

In an example, the control system 106 may be programmed to permit the RC 104 to control the launching of shooting targets from one or more of the target thrower(s) 102 in a variety of ways. For example, in response to a single command signal transmitted by the RC 104, a single thrower 102 may launch multiple targets. In other examples, shooting targets can be thrown from multiple shooting target throwers 102 at the same time, in sequence, at random, etc. responsive to one or more command messages of the RC 104.

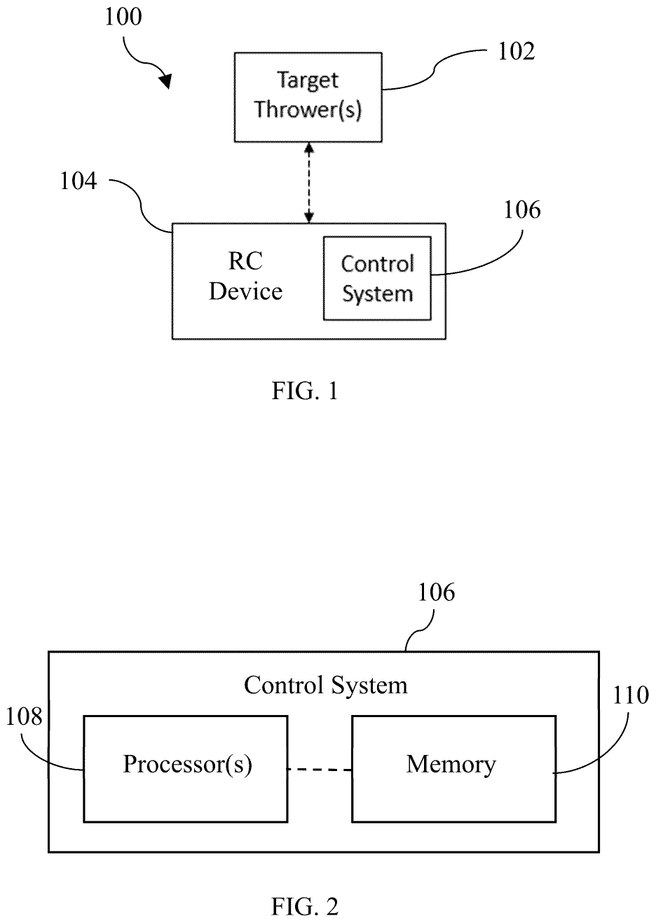

FIG. 2 is a schematic diagram of the control system 106 of the electronic shooting target throwing system 100 according to an embodiment. The control system 106 represents hardware circuitry that includes and/or is connected with one or more processors 108 (e.g., one or more microprocessors, integrated circuits, microcontrollers, field programmable gate arrays, etc.). The control system 106 includes and/or is connected with at least one tangible and non-transitory computer-readable storage medium (referred to herein as memory) 110. For example, the one or more processors 108 are communicatively connected to the memory 110. The memory 110 may store programmed instructions (e.g., software) that are executed by the one or more processors 108 to perform the operations of the control system 106 described herein. The programmed instructions can instruct the one or more processors 108 how to analyze received input signals from a user input, how to identify the target thrower(s) 102 selected to participate in a target launching event, how to generate command messages to control the target throwers 102, and how to communicate the command messages to the intended target throwers 102.

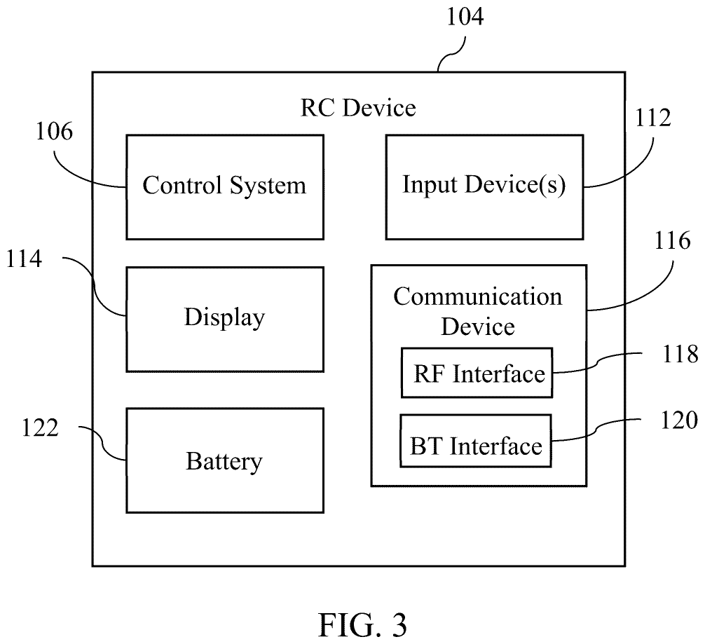

FIG. 3 is a schematic diagram of the RC 104 of the electronic shooting target throwing system 100 according to an embodiment. The RC 104 includes the control system 106, as described above with reference to FIG. 2. The RC 104 may also include at least one user input 112, a display 114, a communication device 116, and a battery 122. The battery 122 is a power supply for the RC 104. For example, the battery 122 supplies electrical energy to power the electronic components of the RC 104. The components of the RC 104 may be mounted within and/or on a housing. The RC 104 may have more components than those shown in FIG. 3.

The user input(s) 112 are user-selectable elements that enable the user to interact with the RC 104. For example, the user manipulates a user input 112 to generate a user selection signal that is communicated to the control system 106. The input(s) 112 may include physical buttons and/or switches, a touchscreen and/or touchpad, a microphone, a peripheral device such as a computer mouse, and/or the like. The user input(s) 112 represent user actuators.

The display 114 visually presents information to the user on an integrated display screen (that is part of the RC 104). The display 114 may provide a graphical user interface that enables the user to interact with the system 100. In an example, the display 114 may be touch-sensitive (e.g., include a touchscreen) that is configured to identify and locate a touch from a user's finger or stylus. In an alternative example of the RC 104, the RC 104 lacks a display.

The communication device 116 enables the RC 104 to wirelessly communicate with the thrower(s) 104 to control the operation of the thrower(s) 104. The communication device 116 includes hardware and circuitry that can wirelessly communicate electrical signals via RF, Bluetooth, and/or the like. For example, the communication device 116 may include transceiving circuitry, one or more antennas, modems, routers, or the like. The transceiving circuitry may include a transceiver or separate transmitter and receiver. The electrical signals can form data packets that in the aggregate represent messages, such as command messages. In various embodiments, the control system 106 generates command messages that are remotely communicated by the communication device 116. In an example, the communication device 116 includes an RF interface 118 for RF communications and a Bluetooth interface 120 for Bluetooth communications. With both interfaces 118, 120, the RC 104 may be able to communicate via RF and Bluetooth. In another embodiment, the communication device 116 includes only the RF interface 118 or only the Bluetooth interface 120, but not both.

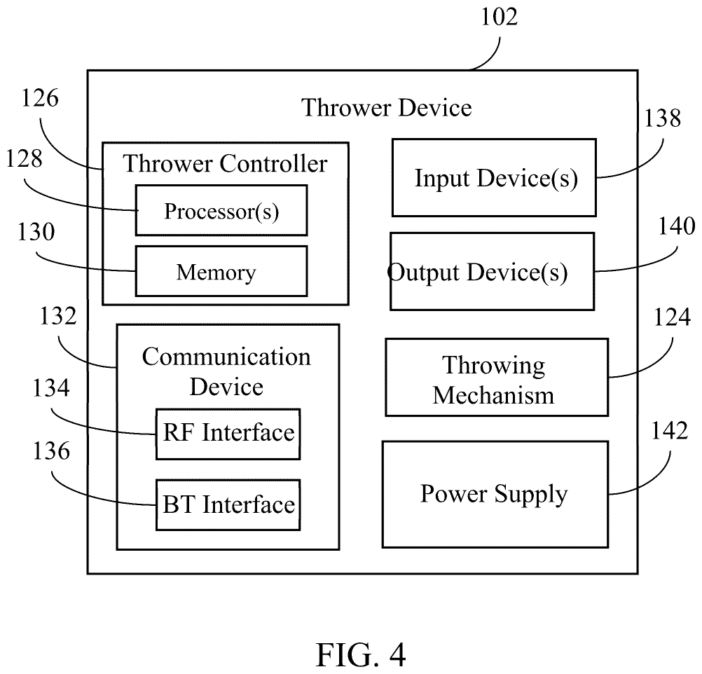

FIG. 4 is a schematic diagram of one thrower 102 of the electronic shooting target throwing system 100 according to an embodiment. The thrower 102 includes a thrower controller 126, a communication device 132, one or more user inputs 138, one or more outputs 140, a throwing mechanism 124, and a power supply 142. The thrower 102 may have more components than those shown in FIG. 4. The power supply 142 powers the operation of the electronic components of the thrower 102. The power supply 142 may include a battery pack, an electrical plug and/or cord, and/or the like. The throwing mechanism 124 includes the elements that function to launch shooting targets as projectiles, such as by converting stored energy into kinetic energy to propel clay targets through the air. The throwing mechanism 124 may include a throwing arm, a motor or spring mechanism, and trajectory adjustment controls.

The thrower controller 126 represents hardware circuitry that includes and/or is connected with one or more processors 128 (e.g., one or more microprocessors, integrated circuits, microcontrollers, field programmable gate arrays, etc.). The thrower controller 126 includes and/or is connected with at least one tangible and non-transitory computer-readable storage medium (referred to herein as memory) 130. For example, the one or more processors 128 are communicatively connected to the memory 130. The memory 130 may store programmed instructions (e.g., software) that are executed by the one or more processors 128 to perform the operations of the thrower 102 described herein. The programmed instructions can instruct the one or more processors 128 how to analyze received input signals from a user input 138, how to interpret and act on received command messages communicated from the RC 104, how to modify a launch vector of the thrower 102, and/or the like.

The communication device 132 enables the thrower 102 to wirelessly communicate with the RC 104 and/or other throwers 104, to coordinate target throwing patterns as described herein. The communication device 132 includes hardware and circuitry that can wirelessly communicate electrical signals via RF, Bluetooth, and/or the like. For example, the communication device 132 may include transceiving circuitry, one or more antennas, modems, routers, or the like. The transceiving circuitry may include a transceiver or separate transmitter and receiver s. The electrical signals can form data packets that in the aggregate represent messages. In various embodiments, the communication device 132 receives command messages generated by the control system 106 of the RC 104. The communication device 132 may convey the command messages and/or content thereof to the thrower controller 126 for implementing the operation instructions contained within the command message. In an example, the communication device 132 includes an RF interface 134 for RF communications and a Bluetooth interface 136 for Bluetooth communications. With both interfaces 134, 136, the RC 104 may be able to communicate via RF and Bluetooth. In another embodiment, the communication device 132 includes only the RF interface 134 or only the Bluetooth interface 136, but not both.

The one or more user inputs 138 are user-selectable elements that enable the user to interact with the thrower 102. For example, the user manipulates an input 138 to generate a user selection signal that is communicated to the thrower controller 126. The input(s) 138 may include physical buttons and/or switches, a touchscreen and/or touchpad, a microphone, and/or the like. For example, one input 138 may be an On/Off button or switch. Another example, input 138 may be another button, such as a “disarm” button.

The one or more outputs 140 visually and/or audibly present information to a user or other person that is nearby. The outputs 140 may include one or more indicator lights, a display, an audio emitter (e.g., speaker), and/or the like.

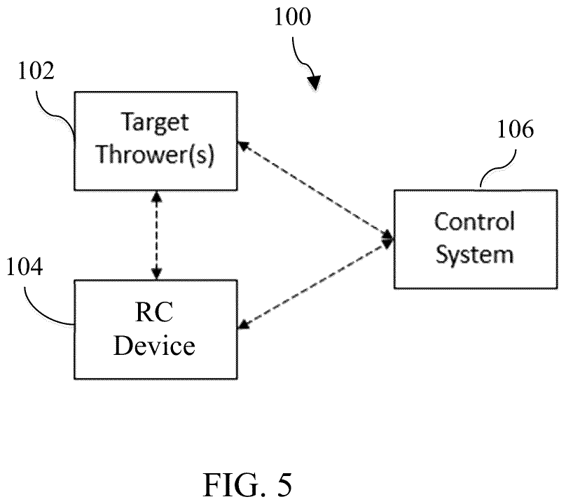

FIG. 5 is a schematic diagram of the electronic shooting target throwing system 100 according to a second embodiment. In FIG. 5, the control system 106 is separate from the RC 104. For example, the control system 106 may be disposed on a discrete device from the RC 104 and the target thrower(s) 102. The control system 106 may communicate with the RC 104 and/or the target thrower(s) 102 via wired or wireless communication links.

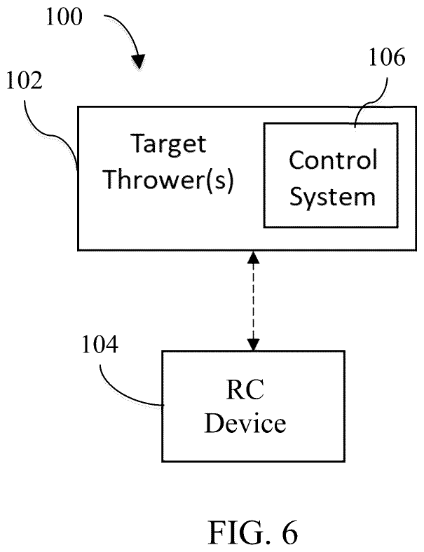

FIG. 6 is a schematic diagram of the electronic shooting target throwing system 100 according to a third embodiment. In FIG. 6, the control system 106 is part of one or more of the target thrower(s) 102. As such, the control system 106 is separate from the RC 104. In another embodiment, the control system 106 may be distributed among the RC 104 and the target thrower(s) 102.

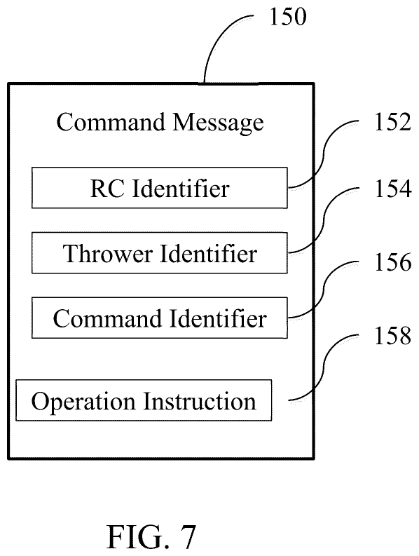

FIG. 7 is a schematic diagram showing the contents of a command message 150 according to an embodiment. The command message 150 may be generated by the control system 106. The command message 150 may be wirelessly communicated from the RC 104 to at least one thrower 102. In the embodiment shown in FIG. 1, the control system 106 is part of the RC 104, so the RC 104 generates and transmits the command message 150. The RC 104 may communicate the command message 150 via the RF interface 118 or the Bluetooth interface 120.

In an embodiment, the command message 150 may include an RC identifier 152, a thrower identifier 154, a command identifier 156, and an operation instruction 158. The RC identifier 152 identifies the sender of the command message 150. The RC identifier 152 may be a code or value that uniquely identifies the RC 104 that is the source of the command message 150, relative to other RCs that may communicate signals received by a thrower 102. In an example, the RC 104 may send or otherwise disclose its particular RC identifier 152 to the thrower 102 during an initial pairing or linking procedure between the two devices 102, 104.

The thrower identifier 154 identifies the intended recipient of the command message 150. The thrower identifier 154 is used to direct the command to the correct target thrower 102. The thrower identifier 154 portion of the command message 150 may identify multiple different throwers 102 when the command message 150 is directed to multiple throwers 102 to collectively participate in a launch sequence. Each thrower identifier 154 may be a code or value that uniquely identifies a particular thrower(s) 102 that is selected as a recipient of the command message 150. Each thrower 102 may have a different corresponding thrower identifier 154 relative to every other thrower 102.

The command identifier 156 identifies the specific message that is communicated from the RC 104 to the one or more throwers 102. For example, a first command message 150 sent from the RC 104 to a first thrower 102 has a first command identifier 156, and a second command message 150 sent from the RC 104 to the first thrower 102 has a second command identifier 156 that is different from the first command identifier 156. Even if the two command messages 150 have the same content, the same sender device, and the same recipient device, the command messages 150 have different command identifiers 156. The command identifier 156 portion of the message 150 enables tracking whether each command message 150 has been received, has been executed, and the like.

For example, when a first target thrower device 102 receives a command message 150, the thrower device 102 may first compare the thrower identifier 154 to the thrower's 102 particular identifier to determine whether the first thrower 102 is an intended recipient of the command message 150. If there is a match between the thrower identifier 154 in the message 150 and the first thrower's 102 identifier, then the thrower controller 126 (shown in FIG. 4) determines that the first thrower 102 is an intended recipient.

A subsequent operation is to compare the RC identifier 152 to one or more RC identifiers associated with RCs that are currently paired, linked, or otherwise authorized for communicating with that specific thrower 102. In an example, the thrower's controller 126 (shown in FIG. 4) compares the RC identifier 152 in the command message 150 to the RC identifiers (e.g., unique serial numbers of RCs) stored in the memory 130. If the RC identifier 152 matches a stored RC identifier, then the controller 126 determines that the source of the command message 150 is authorized (e.g., legitimate). The thrower 102 may execute the command (upon confirming that the thrower 102 is an intended recipient and that the command message 150 is not a duplicate of a message that has already been executed). On the other hand, if the RC identifier 152 does not match any stored RC identifier, then the controller 126 does not execute the command. For example, the thrower 102 does not launch any target in response to the command message 150. In an embodiment, the command message 150 may include a cyclic redundancy check (CRC). The CRC ensures data integrity of the entire message 150, particularly the RC identifier 152, so that the receiving thrower 102 only executes commands from specific authorized RCs 104.

Another operation may be to compare the command identifier 156 to a list of command identifiers stored in the memory 130 (shown in FIG. 4) of the thrower controller 126. In an example, the thrower controller 126 compiles a list of command identifiers 126 of command messages 150 received over time, and stores the list in the memory 130. Upon receiving a new command message 150, the thrower controller 126 compares the command identifier 156 of the new command message 150 to the list of previously-received command identifiers. This comparison is used by the thrower controller 126 to determine if the received command is a new command to be executed, or if it is a duplicate of previously-received command that should be ignored (e.g., not executed). If the command identifier 156 matches one of the previously-received command identifiers, the thrower controller 126 may determine that the command message 150 is a duplicate message and does not execute the commanded instruction. This operation prevents the thrower 102 from executing the same command multiple times and/or forwarding the same command multiple times to other throwers 102 in the network. For example, a given thrower 102 may receive the same command message 150 multiple times due to various different communication pathways in a Bluetooth system/mesh network and/or unexpected reflections that may occur in RF signal transmissions. On the other hand, if the command identifier 156 does not match one of the previously-received command identifiers in the memory 130, the thrower controller 126 determines that the command message 150 is a new message and proceeds to execute the commanded instruction (upon confirming that the thrower 102 is an intended recipient and that the RC 104 that sent the command message 150 is authorized to send commands to the thrower 102).

The operation instruction 158 provides details about the commanded target launch. For example, the operation instruction 158 may indicate the number of targets to launch, one or more times at which to launch a target, a direction (e.g., vector) to launch each target, whether to throw a target immediately or after a designated time delay, what to do after throwing the one or more requested targets, and/or the like. For example, the operation instruction 158 may command throwing a single clay target, two clay targets, or another number of targets. The operation instruction 158 may command throwing the described number of targets immediately in succession or with a designated time delay between launches. Furthermore, the operation instruction 158 may command the thrower 102 to turn Off or enter a service mode after completing the instructed number of target throws.

Although the command message 150 in FIG. 7 has four data elements or components 152, 154, 156, 158, other command messages sent from the RC 104 to one or more of the throwers 102 may include fewer than the four data elements of information, additional information, and/or different information.

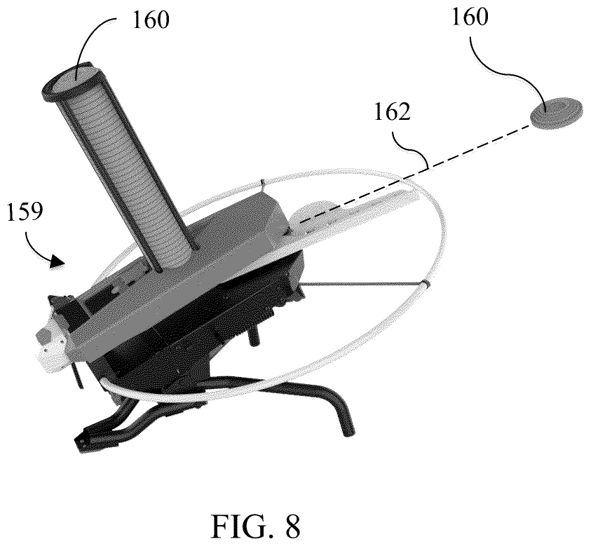

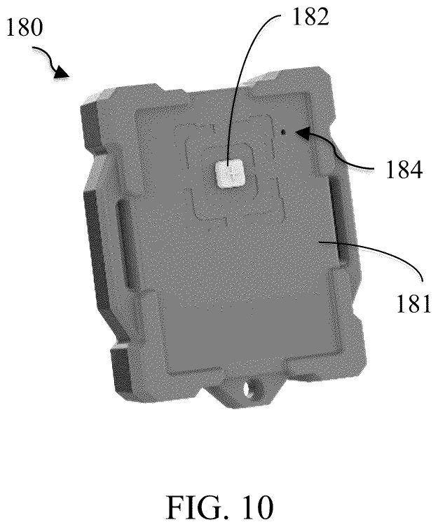

FIG. 8 illustrates a shooting target thrower 159 launching a shooting target 160. The shooting target thrower 159 may represent one of the throwers 102 of the system 100 (shown in FIG. 1). The shooting targets 160 may be discs. The discs may be composed of ceramic (e.g., clay), plastic, or the like. The thrower 159 holds a stack of targets 160 in a queue in preparation for launching. The thrower 159 may launch each target 160 one at a time. The targets 160 are propelled along a trajectory 162. The thrower 159 may be adjustable, which allows a user to modify the trajectory 162. The system 100 described herein can be used with various different types of shooting target throwers 102, such that the throwers 102 of the system 100 are not limited to the particular example thrower 159 shown in FIG. 8.

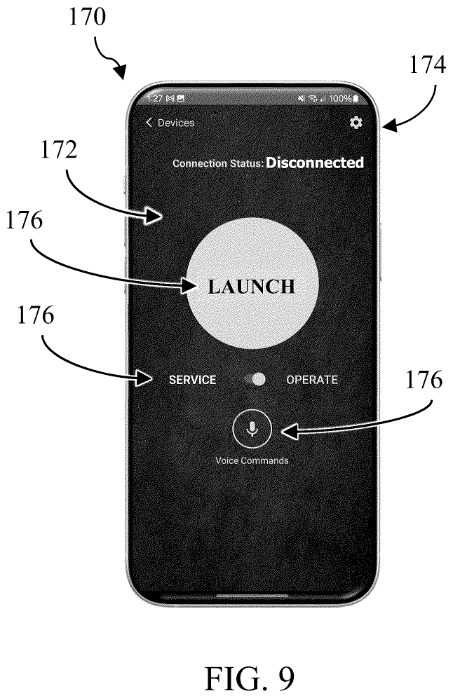

FIG. 9 illustrates a first remote control (RC) 170. FIG. 10 illustrates a second RC 180. Either of the first or second RCs 170, 180 may represent the RC 104 of the system 100 shown in FIG. 1. Referring first to FIG. 9, the first RC 170 is a mobile computer, such as a smartphone or tablet. The RC 170 may present a graphical user interface (GUI) 172 on a display screen 174. The GUI 172 allows a user to interact with the electronic shooting target throwing system 100, such as to generate command signals 150. The GUI 172 may include virtual user-selectable elements 176 (e.g., virtual buttons) that may be selected by the user by tapping or pressing a corresponding location of the display screen 174. For example, the user-selectable elements 176 may include a “launch” button, a “voice command” button, a mode select button that allows the user to switch between service mode and operate mode, and navigation buttons. For example, the navigation button may include a “back” or “previous” button and a settings button. The GUI 172 may have other layouts and user-selectable elements 176 in other embodiments. Selection of the “launch” button may trigger the RC 170 to transmit the command signal 150 to one or more throwers 102, instructing the intended recipient thrower(s) 102 to launch at least one shooting target.

In an example, the system 100 may provide a mobile application (“app”) that is stored in part on the RC 170. For example, the users of the system 100 may download the mobile application for the system 100 onto their RC 170 (e.g., mobile computing). To access the throwing system app, a user may open or initiate the mobile application on the RC 170. The mobile application provides the GUI 172. The mobile application may require at least one form of authentication (e.g., password, security code on a trusted, face or other biological recognition, or the like) before granting the user access to controlling the thrower(s) 102.

In an example, the RC 170 is a Bluetooth-capable device that can establish communication links, or pairings, with the thrower(s) 102. For example, the throwers 102 may also be Bluetooth-capable. Once paired with a particular thrower 102, the RC 170 can transmit command messages 150 to the thrower 102 via Bluetooth, at least while in a Bluetooth transmission range of each other.

In an example use application, a user may use Bluetooth communication to send a command message 150 to a thrower 102. The user may open the mobile application and select settings for commanding that the thrower 102 launch two shooting targets per activation. When ready to launch, the user may actuate the RC 104 by pressing the Launch button or speaking a designated voice command, such as “pull.” The RC 104, via the mobile application, generates and transmits a command message to the thrower 102. The thrower 102 receives the command message and executes the command message upon confirming that the command message is legitimate and intended for the thrower 102. The thrower 102 may execute the operation instruction in the command message by first launching one target. The thrower 102 may reset and launch a second target after a set period of time or when the thrower 102 is ready to launch the second target. For example, the thrower 102 may communicate with the mobile application to inform the application when the thrower 102 is ready to launch the second target. In that case, the application may communicate a second launch command to the thrower 102 for the thrower 102 to launch the second target.

In another example use application using the Bluetooth mobile application, the user may use a single RC 104 to launch targets from multiple different throwers 102 according to a selected launch pattern. The user may select the launch pattern using the GUI 172 of the mobile application on the RC 170, as shown in FIG. 9. The GUI 172 may provide the user with multiple launch pattern options. A first example launch pattern option is to have multiple throwers 102 simultaneously launch targets (e.g., at the same time). A second example launch pattern option is to have multiple throwers 102 launch targets in an ordered sequence. For example, a first thrower 102 launches a first target at a first time, then a second thrower 102 launches a second target after a designated time period following the first time. The user may select the throwers 102 to use in the ordered sequence as well as the order at which the selected throwers 102 launch. A third example launch pattern option is to have multiple throwers 102 launch targets in a seemingly random order that is not selected by the user. The control system 106 may determine the order that the selected throwers 102 launch targets. The random sequence may also have a randomized (e.g., non-uniform) time delay between target launches. After selecting the desired launch pattern, the user may actuate the RC 104, such as by pressing the Launch button or providing a voice command, to trigger the RC 104 to generate and send the command message to the throwers 102.

In an example, the RC 104 may send the command message to throwers A and B, and the operation instruction may provide details about number of targets for each thrower to launch, timing, and optionally also launch trajectory (e.g., direction, vector, angle of incline, power, etc.). As described above, the mobile application (e.g., RC 104) generating the command message includes the thrower identifiers (e.g., its unique serial number or MAC address) of the selected throwers 102 in the command message so the command message is specifically dedicated (e.g., addressed) to the selected throwers 102 that will participate in the launch sequence. The throwers 102 can be arranged with different distances from the shooter, or with different angles and/or elevations, to create unique, customizable scenarios for target practice.

In an embodiment, the system 100 includes a plurality of throwers 102 that are spaced apart from one another in an area or zone. The throwers 102 may be communicatively connected to each other to form a mesh network 190. The throwers 102 in the mesh network function as nodes (e.g., intermediary network communication devices) to relay command messages to other throwers 102 out of communication range of the RC 104.

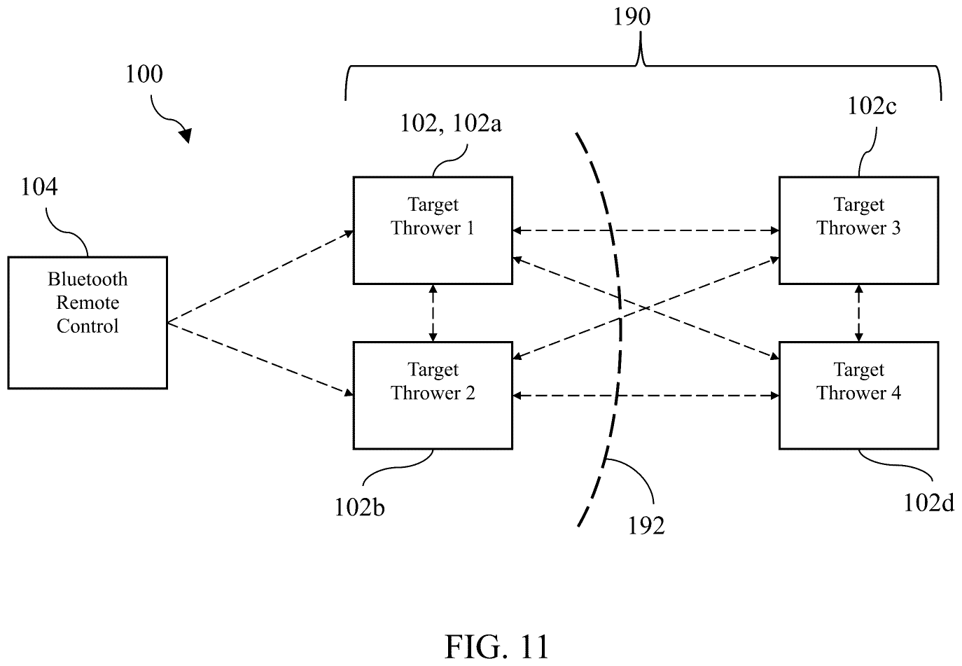

FIG. 11 illustrates an RC 104 in communication with a mesh network 190 of connected throwers 102. The mesh network 190 in FIG. 11 includes a first thrower 102a, a second thrower 102b, a third thrower 102c, and a fourth thrower 102d. The throwers 102 are communicatively connected to each other via communication links. In an example, the communication links are wireless links. The throwers 102 may communicate over the links using Bluetooth messages (e.g., messages transmitted point-to-point according to the Bluetooth protocol). The Bluetooth interface 120 of the RC 104 may have a relatively limited range. For example, the communication range 192 of the RC 104 may be about 80-100 yards, or less if obstructions are present. Obstructions may include buildings, trees, bridges, other structures, and the like. In an example, the communication range 192 refers to the range of Bluetooth communications from the RC 104. The RC 104 may have another communication range that represents the range of RF communications via the RF interface 118. The mesh network 190 described herein may be used to relay Bluetooth-transmitted command messages, RF-transmitted command messages, or both Bluetooth and RF-transmitted messages among the throwers 102 and the RC 104.

The throwers 102 are located at different distances from the current location of the RC 104. The RC 104 may only be within range of some of the target throwers 102. For example, the first and second throwers 102a, 102b are located a closer to the RC 104 than the distance from the third and fourth throwers 102c, 102d to the RC 104. In other words, the first and second throwers 102a, 102b are generally located between the RC 104 and the third and fourth throwers 102c, 102d. The first and second throwers 102a, 102b are located within the communication range 192 of the RC 104. The third and fourth throwers 102c, 102d are located outside of the communication range 192 of the RC 104. As a consequence, the RC 104 may not be able to directly communicate with the third thrower 102c or the fourth thrower 102d due to wireless communication limitations. In an example, the target throwers 102 in the mesh network 190 can relay communications received from the RC 104 and/or other target thrower 102 to other throwers 102 in the network 190, effectively extending the communication range beyond the direct communication range 192 of the RC 104. Accordingly, the Bluetooth communications may form a mesh network 190, with the target throwers 102 acting as nodes of the mesh network 190. A technical effect is that the user can control throwers 102c, 102d that conventionally would be too far away from the RC 104 to enable remote control, which allows for greater variation in launch sequences using multiple throwers 102.

In an example, the user may open the mobile app associated with the system 100 on the Bluetooth-capable RC 170, as shown in FIG. 9 for example. The user may provide user input selections on the GUI indicating operation instructions for the desired launch sequence.

The operation instructions may include, for example, how the clay targets are to be launched and from which target throwers 102 (a firing sequence or order). After the user presses the “Launch” button or speaks a designated voice command (e.g., “pull”), which represents a triggering event, the Bluetooth remote control 170 transmits at least a first command message for one or more intended recipient throwers 102 in the mesh network 190. One or more of the throwers 102 that are within range 192 directly receive the first command message. If the thrower(s) 102 that receive the first command message determine that the receiving thrower(s) 102 are not the intended recipient, those thrower(s) 102 operate as intermediary nodes. An intermediary node forwards or repeats the first command message to other target throwers, such as throwers 102c, 102d that are within the range of the intermediary node but outside of the range of the RC 104.

In an example, the throwers 102 may store a list of the thrower identifiers that uniquely identify each of the throwers 102 in the mesh network 190. An intermediary node thrower 102 may determine, based on a comparison of the thrower identifier 154 in the command message 150 to the list of stored identifiers, which specific thrower(s) 102 outside of the communication range 192 are the intended recipients. For example, the first thrower 102a in FIG. 11 may determine that the thrower 102d is the intended recipient of the command message. In that case, the first thrower 102a may only send the command message 150 to the fourth thrower 102d. For example, the first thrower 102a may not forward the command message to the third thrower 102c or other thrower s 102 that are not intended recipients. The first thrower 102a may communicate the command message along a dedicated Bluetooth communication link between the first and fourth throwers 102a, 102d.

Optionally, a thrower 102 may operate as an intended recipient and an intermediary node upon determining that the thrower 102 is one of multiple different intended recipients of the command message. In that case, the thrower 102 may both execute the operation instruction in the command message and forward the command message to other target throwers 102. The target throwers 102 may use the thrower identifier 154 in the command message to determine whether or not the particular thrower 102 is an intended recipient of the command message, and therefore whether or not the thrower 102 executes the operation instruction 158 of the command message.

In the illustrated example configuration, the mesh network 190 includes one Bluetooth RC 104 and four throwers 102a-d (Target Throwers 1-4). Target Throwers 1 and 2 are within the range of the Bluetooth Remote Control and Target Throwers 3 and 4 are outside of the range of the Bluetooth Remote Control (but within the range of Target Throwers 1 and 2). In a first example, the user actuates the RC 104 to control the first thrower 102a to launch one shooting target. The user may use the GUI or a voice command to select the first thrower 102a as the intended recipient of the command message. The user then actuates the RC 104 to generate the command message by pressing a button, such as a launch button, or by providing a dedicated voice command (e.g., exclaiming the word “Pull”). The Bluetooth interface of the RC 104 transmits the command message directly to the first thrower 102a which is within range of the RC 104. The first thrower 102a executes the operational instructions upon receipt (and review) of the command message.

In a second example, the user actuates the RC 104 to control the fourth thrower 102d to launch a shooting target. The user's steps may be similar to the first example, except that the user selects the fourth thrower 102d as the intended recipient via the GUI and/or voice command. Because the fourth thrower 102d is out of range of the RC 104, the RC 104 has to use at least one of the first and second throwers 102a, 102b as nodes to relay the command message to the fourth thrower 102d. For example, the RC 104 transmits the command message to the first thrower 102a and/or the second thrower 102b. The throwers 102a, 102b determine, via the thrower identifier 154 (shown in FIG. 7), that the intended recipient is the fourth thrower 102d. Therefore, neither of the first or second throwers 102a, 102b executes the command (e.g., neither launches a target). The first thrower 102a and/or the second thrower 102b forwards the command message to the fourth thrower 102d. The fourth thrower 102d receives the command message from the first and/or second throwers 102a, 102b. Upon reviewing and confirming that the fourth thrower 102d is the intended recipient, the command message is not a duplicate that has already been executed, and the RC 104 that generated the command message is authorized to control the fourth thrower 102d, the fourth thrower 102d executes the operational instructions of the command message, launching a target.

In an embodiment, the system 100 includes a Bluetooth mobile application that is stored on the RC 104 that has Bluetooth capability. The mobile application is used for connecting to and activating a thrower 102, leveraging one-to-one server to client communication of the Bluetooth stack. The Bluetooth mobile application may be run on smart phone, tablet, or other suitable such as RC 170. The mobile application may establish a connection to the thrower 102 via Bluetooth and identify the thrower 102 by its unique serial number or MAC address (broadly, the unique thrower identifier 154). Utilizing Bluetooth communication, the Bluetooth mobile application can send commands to the thrower 102 to ready or to throw a clay pigeon or other target. The Bluetooth mobile application can establish multiple connections to multiple concurrent throwers 102 (forming a one-to-many configuration).

The Bluetooth mobile application can utilize a single connection and Bluetooth commands to automate a throwing pattern such as to throw consecutive clays in a row (e.g., from different throwers 102) when activated. The Bluetooth mobile application can utilize multiple concurrent Bluetooth connections and Bluetooth commands to synchronize launch patterns. One example launch pattern may be to throw a clay from each connected thrower 102 simultaneously. Another example may be for the throwers 102 to launch in an ordered sequence, one at a time. A third example launch pattern may be for the throwers 102 to launch in a seemingly random order. The Bluetooth mobile application can be used to configure various different combinations of synchronized, sequential, or randomized throwing patterns performed by a single thrower 102 or multiple throwers 102. The Bluetooth mobile throwing action can be activated (e.g., to start the throwing sequence) by any combination of actions within the application. For example, a user may provide one or more user input signals, such as taps, swipes or gestures on a touchscreen or voice commands. Furthermore, the activation signal may be a received command message from another connected or application, such as in the case of a mesh network.

Referring now back to FIG. 10, the second RC 180 includes a housing 181, at least one button 182, and at least one indicator light 184. The button 182 shown in FIG. 10 represents one of the user inputs 112 shown in FIG. 3. The indicator light 184 represents an output, such as the display 114 in FIG. 3. The second RC 180 may be a handheld RF remote controller. In an example, the RC 180 communicates via RF signals. As such, the RF device 180 includes the RF interface 118 shown in FIG. 3. In an example, the RC 180 does not have a Bluetooth interface.

In an embodiment, an RC 104 that operates via RF communications, such as the RC 180 in FIG. 10, performs a pairing procedure to establish a communication link with each thrower 102 that the RC 104 intends to wirelessly control. The pairing procedure is the process for authorizing the RC 104 for controlling the respective thrower 102. If an RC 104 intends to control multiple throwers 102, the pairing procedure may be repeated for each thrower 102.

In an embodiment, the pairing procedure requires positive actuation on both the RC 104 and the thrower 102, thereby requiring a user to be present at both throwers 102, 104. For example, the pairing procedure may require physical enablement of pairing on the thrower 102 and multi-step pairing operations from the wireless RF remote control 104. The physical enablement may include physically manipulating one or more buttons, switches, or other input elements of the thrower 102. In an example embodiment, the procedure may first involve turning On the thrower 102 or verifying that the thrower 102 is On. This step may be achieved by pressing a power button on the thrower 102. Then, the user may hold a designated linking button on the thrower 102 for at least a first designated time period. In an example, the designated linking button may be a “disarm” button. The designated time period may be a number of seconds, such as 5 seconds. The first designated time period may be greater or less than 5 seconds in other examples. Upon reaching the designated time period, an indicator light on the thrower 102 may flash. The flashing light notifies the user at the thrower 102 that the first designated time period has been reached.

Subsequently, the user may press a designated button on the RC 104. With reference to FIG. 10, the designated button may be the button 182. In response, the RC 104 may communicate a link request signal. If the thrower 102 receives the link request signal while the indicator light is flashing, the controller 126 of the thrower 102 may provide an indication that the link request signal is received. The indication may be to modify one or more visual characteristics of the light emitted by the indicator light. For example, the controller 126 may change the rate (e.g., frequency) at which the light flashes. The controller 126 may increase the rate upon receiving the link request signal, relative to the (non-zero) rate at which the flashing indicator light was flashing prior to receiving the link request signal. In another example, the controller 126 of the thrower 102 may use audio alerts in addition to, or instead of, the flashing indicator light to indicate the progression of the pairing procedure. In an example, upon being alerted to the receipt of the link request signal, the user may again press a button on the RC 104. In an example, the user may press the same button a second time, such as the button 182 shown in FIG. 10.

The second button actuation may trigger the RC 104 to communicate a link confirmation signal. If the thrower 102 receives the link confirmation signal, the two devices are successfully paired for future communications between the two devices, at least for the duration of a given target launching session. The controller 126 of the thrower 102 may indicate the successful pairing or linking of the two devices 102, 104 by modifying the light emitted by the indicator light. For example, the controller 126 may control the indicator light to emit a solid (e.g., continuous) light, as opposed to a flashing light. The thrower 102 is now paired to receive commands from the specific RC 104.

In an embodiment, the RC 104 sends the RC identifier 152 to the thrower 102 during the pairing procedure. The RC identifier 152 is the unique serial number associated with the particular RC 104. The RC identifier 152 may be included in the link request signal and/or the link configuration signal. Upon a successful pairing procedure, the controller 126 of the thrower 102 may store the RC identifier 152 in the memory 130. Storing the RC identifier 152 establishes that the RC 104 is authorized to remotely control the particular thrower 102. For example, when the thrower 102 receives a command message to launch one or more targets, the controller 126 of the thrower 102 confirms that the RC 104 that generated the command message is authorized before executing the command message. The confirmation process involves comparing the RC identifier received in the message to stored RC identifiers associated with authorized RCs. If there is match, the thrower 102 executes the command (if it is the intended recipient and the operation has not already been executed). The RC identifier 152 is provided in command messages sent by the RC 104 as a way to uniquely identify the source of the command messages as being from an authorized RC 104 (that successfully completed the pairing procedure to the thrower 102).

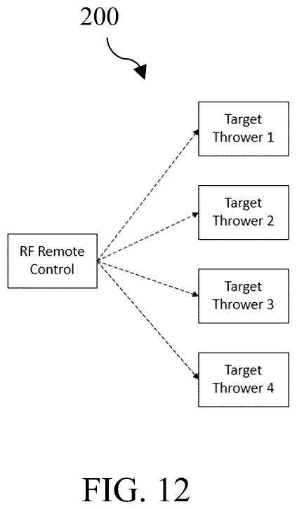

When a similar pairing procedure is repeated between the same wireless RC 104 and a second, third, fourth, or more electronic throwers 102, then each thrower 102 will act on commands from the same uniquely identified RC 104. As an example, after successful pairings, the RC 104 may control a plurality of throwers 102 to launch targets, in a one-to-many configuration. FIG. 12 shows a first example one-to-many configuration 200 in which a single RC 102 controls multiple throwers 102 via RF-transmitted command signals. This allows multiple RF RCs 104 and multiple target throwers 102 to be used at the same time and in the same area (within the range of the RF signals). Different RCs 104 may be paired to different throwers 102 as well. This allows multiple RF command signals to be used at the same time for controlling different target throwers 102 paired with the different RCs 104, without the command from one RC 104 necessarily controlling all of the target throwers 102 in the area.

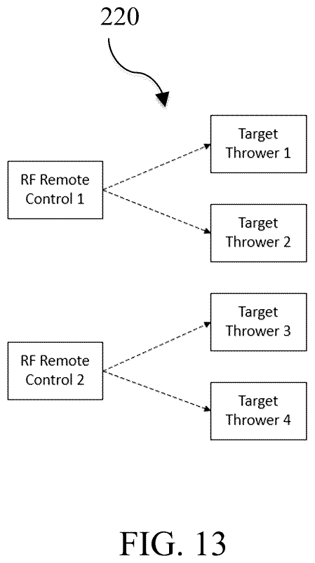

FIG. 13 shows a second example configuration 220 of the electronic shooting target throwing system 100. In this implementation, multiple RF RCs 104 are used (e.g., RF remote control 1 and RF remote control 2). Each RC controls a subset of the throwers 102 (e.g., target throwers 1-4). Each target thrower 1-4 has been paired with only one of the RF RCs. As such, each target thrower analyzes a received command signal to look for the unique serial number associated with the specific RC that is paired to the thrower. In this example, RF Remote Control 1 is paired with Target Throwers 1 and 2, and RF Remote Control 2 is paired with Target Throwers 3 and 4. In an example launch operation, RF Remote Control 1 sends command (with unique remote identifier). Due to the proximity of the throwers to the Remote Control 1, all four of the Target Throwers 1-4 may receive the command message from RF Remote Control 1. Target Throwers 1 and 2 receive the command message, match the remote identifier to the paired remote identifier, and execute the operation instruction 158 of the command message upon verifying the match. Target Throwers 3 and 4 receive the command message and fail to verify a match between the RC identifier 152 in the command message and the stored RC identifier(s) associated with authorized (e.g., paired) RCs. Target Throwers 3 and 4 are looking for the remote identifier of RF Remote Control 2. As a result, Throwers 3 and 4 do not execute the operation instruction 158 of the command message. A similar, but inverse, situation may occur when the RF Remote Control 2 sends a command message that is received by all four of the Target Throwers 1-4. For example, Throwers 3 and 4 may execute the operation instruction 158, but Throwers 1 and 2 do not execute the operation instruction 158.

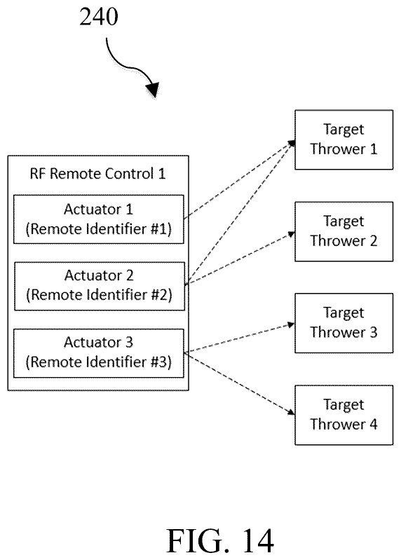

FIG. 14 shows a third example configuration 240 of the electronic shooting target throwing system 100. In this implementation, one RF RC 104 is used to selectively control one, some, or all of the throwers 102. For example, the one RC 104 may control different subgroups of the throwers 102. One or more thrower s 102 may be included in multiple subgroups.

In the illustrated example, the one RF RC 104 includes multiple (e.g., 2, 3, 4, etc.) unique remote identifiers and the throwers 102 are paired with one or multiple unique remote identifiers (broadly, multiple RF remote controls) of the same RC 104. In this embodiment, the RF Remote Control 1 may include one RF transmitter and multiple actuators (e.g., buttons, switches, etc.) each associated with a different corresponding unique remote identifier 152. When one actuator is pressed, the command message includes the unique remote identifier 152 associated with the pressed actuator. In this manner, RF Remote Control 1 generates command messages that have different remote identifiers 152 depending on which actuator is pressed.

Other embodiments are within the scope of the present disclosure. For example, each actuator of the same RC 104 may include an associated RF transmitter. In another example, the RC 104 may have a mode switch (instead of multiple actuators) which is used to set which unique remote identifier 152 is included in the command message, and, therefore, which throwers 102 are to be operated at a given time and/or in a given launch sequence.

In the illustrated example, RF Remote Control is paired with Target Throwers 1-4. Actuation of Actuator 1 operates Target Thrower 1 (Target Thrower 1 is paired with Remote Identifier #1 associated with Actuator 1). Actuation of Actuator 2 operates Target Throwers 1 and 2 (Target Thrower 1 is paired with both Remote Identifier #1 and Remote Identifier #2, and Target Thrower 2 is paired with Remote Identifier #2 associated with Actuator 2). Actuation of Actuator 3 operates Target Throwers 3 and 4 (Target Throwers 3 and 4 are paired with Remote Identifier #3 associated with Actuator 3).

In an example operation sequence, the RC 104 (e.g., RF Remote Control 1) may receive a user input signal that the user selected Actuator 1. The control system 106 of the RC 104 may, in response, generate a command message corresponding to Actuator 1. The command message may be transmitted by the RC 104 and received by multiple throwers 102, such as all four of Throwers 1-4. Target Thrower 1 receives the command, matches Remote Identifier #1 to one of the paired remote identifiers and executes the operation instruction of the command. Target Throwers 2-4 compare Remote Identifier #1 to the paired remote identifier, determine that they do not match, and do not execute the operation instruction of the command message. If, for example, the user presses Actuator 2, the RF Remote Control sends a command message with Remote Identifier #2. Target Throwers 1 and 2 match the Remote Identifier #2 to the paired remote identifier and execute the operation instruction of the command message. Target Throwers 3 and 4 compare Remote Identifier #2 to the paired remote identifier, determine that they do not match, and do not execute the operation instruction of the command message. If Actuator 3 is selected, Target Throwers 3 and 4 execute the received command message, but Target Throwers 1 and 2 do not due to failure to match the Remote Identifier #3.

It is understood the RF remote control architectures described with reference to FIGS. 12-14 can be combined together to create numerous different systems with one or more RF remote controls and one or more target throwers. Such combinations and permutations using the principles outlined on the previous pages are known and understood by the person of ordinary skill.

In addition, it is understood that for the RF remote control which is able to send out multiple unique remote identifiers, that such an RF remote control can be used to synchronize throwing (e.g., launch) patterns. For example, the RC 104 can control multiple throwers 102 to throw targets from each connected thrower 102 simultaneously, in an ordered sequence, in a seemingly random order, and/or the like. For example, the RF remote control may receive user input (via a user interface) regarding a firing sequence. The RF remote control may send out the various commands (with the different unique remote identifiers) based on the selected/inputted firing sequence—e.g., with delay or no delay between commands, in a user-selected sequence and time delay or in randomized sequence, such as with randomized time delay between launches.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

### OTHER STATEMENTS OF THE DISCLOSURE

The following are statements or features described in the present disclosure. Some or all of the following statements may not be currently presented as claims. Nevertheless, the statements are believed to be patentable and may subsequently be presented as claims.

Associated methods corresponding to the statements or apparatuses or systems below are also believed to be patentable and may subsequently be presented as claims. It is understood that the following statements may refer to and be supported by one, more than one, or all the embodiments described above.

A1. An electronic shooting target throwing system comprising:
a remote control (RC) including a control system and at least a first wireless interface, the RC configured to generate a command message and wirelessly communicate the command message, via the first wireless interface, to one or more throwers, each thrower configured to launch shooting targets into the air as projectiles, wherein the RC generates the command message to include an operation instruction to launch at least one shooting target,
wherein the RC is configured to establish a communication link to at least a first thrower of the one or more throwers, wherein a pairing procedure to establish the communication link involves physical enablement of pairing on the first thrower and multiple linking signals communicated by the RC.

A2. The statement of A1, wherein during the pairing procedure, the RC device is configured to: (i) communicate a link request signal while the first thrower device is in a pairing mode, the link request signal communicated in response to receiving a first user input on a actuator of the RC device; and (ii) communicate a link confirmation signal in response to receiving a second user input on the actuator of the RC.

B1. An electronic shooting target throwing system comprising:
a remote control (RC) including a control system and at least a first wireless interface, the RC configured to generate a command message and wirelessly communicate the command message, via the first wireless interface, to one or more throwers, each thrower configured to launch shooting targets into the air as projectiles, wherein the RC generates the command message to include an operation instruction that instructs a first thrower of the one or more throwers and a second thrower of the one or more throwers to launch a plurality of shooting targets in a designated launch sequence.

B2. The statement of B1, wherein the RC is configured to generate the command message to include the operation instruction that instructs the first thrower and the second thrower to launch shooting targets one of (i) at the same time, (ii) at different times according to an ordered sequence, or (iii) at different times according to a random sequence.

What is claimed is:

1. An electronic shooting target throwing system comprising:
a plurality of throwers each configured to launch shooting targets into the air as projectiles, each of the throwers including at least one wireless interface and a thrower controller, the throwers communicatively connected to one another to form a mesh network, wherein a first subgroup of one or more of the throwers is located within a communication range of a remote control (RC) and a second subgroup of one or more of the throwers is outside of the communication range,
wherein, in response to a first thrower of the first subgroup receiving a command message communicated from the RC that identifies at least a second throwers that is in the second subgroup as an intended recipient of the command message, the first thrower is configured to communicate the command message to at least the second thrower, effectively extending the communication range of the RC.

2. The system of claim 1, wherein the first thrower is communicatively connected to the second thrower via a Bluetooth connection.

3. The system of claim 1, wherein the first thrower is configured to analyze contents of the command message that is received, the contents including one or more thrower identifiers and an operation instruction to launch at least one shooting target, each thrower identifier uniquely identifying one intended recipient of the command message.

4. The system of claim 3, wherein the first thrower compares the at least one thrower identifier to a first thrower identifier uniquely associated with the first thrower, and, in response to determining that the first thrower identifier does not match any of the one or more thrower identifiers in the command message, the first thrower does not execute the operation instruction to launch at least one shooting target.

5. The system of claim 3, wherein the first thrower compares the at least one thrower identifier in the command message to a list of thrower identifies that uniquely identify each of the throwers in the mesh network, and in response to determining that a thrower identifier in the command message matches a second thrower identifier associated with the second thrower, the first thrower is configured to communicate the command message to the second thrower without sending the command message to a third thrower in the mesh network.

6. The system of claim 1, further comprising the second thrower, wherein the second thrower is configured to analyze contents of the command message that is received from the first thrower, the contents including an RC identifier and an operation instruction to launch at least one shooting target, the RC identifier uniquely identifying the RC that communicated the command message,
wherein the second thrower is configured to compare the RC identifier in the command message to a list of authorized RC identifiers, and the second thrower does not execute the operation instruction to launch at least one shooting target in response to determining that the RC identifier does not match any of the authorized RC identifiers in the list.

7. The system of claim 1, further comprising the second thrower, wherein the second thrower is configured to analyze contents of the command message that is received from the first thrower, the contents including a command identifier and an operation instruction to launch at least one shooting target, the command identifier uniquely identifying the particular command message communicated by the RC,
wherein the second thrower is configured to compare the command identifier in the command message to a list of previously-received command identifiers associated with other command messages previously executed, and the second thrower does not execute the operation instruction to launch at least one shooting target in response to determining that the command identifier matches one of the previously-received command identifiers in the list.

8. The system of claim 1, further comprising the second thrower, wherein the command message includes one or more identifiers and an operation instruction to launch at least one shooting target, wherein the second thrower is configured to execute the operation instruction to launch at least one shooting target in response to determining at least two of: (i) the second thrower is the intended recipient of the command message, (ii) the RC is authorized to control the second thrower, and (iii) the operation instruction in the command message has not been executed by the second thrower already.

9. The system of claim 1, wherein the first thrower and the second thrower are both intended recipients of the command message, and the first thrower is further configured to execute an operation instruction of the command message to launch one or more shooting targets from the first thrower.

10. The system of claim 9, wherein the operation instruction of the command message instructs the first thrower and the second thrower to launch a plurality of shooting targets in a designated launch sequence.

11. The system of claim 10, wherein the launch sequence in the command message includes one of (i) a simultaneous launch of shooting targets by both the first thrower and the second thrower, (ii) an ordered sequence of launches by the first thrower and the second thrower at different times with a fixed interval between launches, or (iii) a random sequence of launches by the first thrower and the second thrower at different times without a fixed interval between launches.

12. The system of claim 10, wherein the communication range of the RC is a Bluetooth communication range.

13. An electronic shooting target throwing system comprising:
a remote control (RC) including a control system and at least a first wireless interface, the RC configured to generate a command message and wirelessly communicate the command message, via the first wireless interface, to one or more throwers, each thrower configured to launch shooting targets into the air as projectiles,
wherein the RC generates the command message to include a command identifier and an operation instruction to launch at least one shooting target, the command identifier uniquely identifying the particular command message communicated by the RC.

14. The system of claim 13, wherein the first wireless interface is a Bluetooth interface that wirelessly communicates the command message as a Bluetooth communication link directly to a first thrower of the one or more throwers.

15. The system of claim 13, wherein the first wireless interface is a radio frequency (RF) interface.

16. The system of claim 13, wherein the RC is configured to establish a communication link to at least a first thrower of the one or more throwers, wherein a pairing procedure to establish the communication link involves physical enablement of pairing on the first thrower and multiple linking signals communicated by the RC.

17. The system of claim 16, wherein, during the pairing procedure, the RC is configured to:
(i) communicate a link request signal while the first thrower is in a pairing mode, the link request signal communicated in response to receiving a first user input on an actuator of the RC; and
(ii) communicate a link confirmation signal in response to receiving a second user input on the actuator of the RC.

18. The system of claim 13, wherein the RC is configured to generate the command message to include an operation instruction that instructs the first thrower and a second thrower to launch a plurality of shooting targets in a designated launch sequence, wherein the launch sequence involves launching shooting targets from first and second throwers of the one or more throwers one of (i) at the same time, (ii) at different times according to an ordered sequence, or (iii) at different times according to a random sequence.

19. The system of claim 13, wherein the RC is configured to generate the command message to further include (i) an RC identifier that uniquely identifies the RC that generates the command message, and (ii) a thrower identifier that uniquely identifies one of the one or more throwers that is an intended recipient of the command message.

20. The system of claim 13, wherein the one or more throwers include multiple throwers communicatively connected to one another to form a mesh network, wherein a first subgroup of the throwers is located within a communication range of the RC and a second subgroup of the throwers is outside of the communication range, wherein a first thrower in the first subgroup is configured to receive the command message and communicate the command message to a second thrower in the second subgroup to effectively extend the communication range of the RC.
